(19) United States
(12) Patent Application Publication
(10) Pub. No.: US 2005/0221808 A1
(43) Pub. Date: Oct. 6, 2005

(54) Method of automatically altering the behaviour of a wireless information device

(76) Inventors: Petter Karlsson, London (GB); Dominic Butler, London (GB); Clive Whitear, London (GB); Leigh Banham, London (GB); Chris Shepherd, Impington (GB)

Correspondence Address: SYNNESTVEDT LECHNER & WOODBRIDGE LLP, P O BOX 592, PRINCETON, NJ, 08542-0592, US

(21) Appl. No.: 10/503,353

(22) PCT Filed: Feb. 3, 2003
(86) PCT No.: PCT/GB03/00425

§ 371 Date: Apr. 18, 2005

(30) Foreign Application Priority Data
Feb. 1, 2002 (GB) 0202373.7

(51) Int. Cl. H04M 3/00; H04M 1/00

(52) U.S. Cl. 455/418; 455/566

(57) ABSTRACT

A device user defines a criteria by selecting an item from a list of possible items displayed on the device or a different wireless information device; the behaviour of the device is automatically altered when that device satisfies the user defined criteria by causing the device to automatically send a user defined message to a user defined contact.

### BACKGROUND OF THE INVENTION

1. Field of the Invention

This invention relates to a method of automatically altering the behaviour of a wireless information device. The term ‘wireless information device’ used in this patent specification should be expansively construed to cover any kind of device with one or two way communications capabilities and includes without limitation radio telephones, smart phones, communicators, personal computers, computers and application specific devices. It includes devices able to communicate in any manner over any kind of network, such as GSM or UMTS mobile radio, Bluetooth™, Internet etc.

2. Description of the Prior Art

There has been considerable work in recent years devoted to making wireless information devices, particularly mobile telephones, possess functionality that cannot be replicated using fixed devices. One unique characteristic of a wireless information device is that its location will alter; many innovations have centered on making the behaviour of the mobile telephone alter as its location changes: for example, reference may be made to PCT/US02/18671 to Nokia which describes adjusting the functions (e.g. profiles) of a mobile telephone depending on its location. This allows, for example, the mobile telephone to automatically change its behaviour to non-ringing if it is in a theatre, or to turn off RP functionality when by an aeroplane etc.

### SUMMARY OF THE PRESENT INVENTION

In a first aspect of the present invention, there is a method of automatically altering the behaviour of a wireless information device, comprising the steps of:
(a) enabling a user to define one or more criteria defining a logical location by selecting an item from a list of possible logical locations displayed on the device;
(b) altering the behaviour of the device when that device satisfies the user defined logical location criteria by causing the device to automatically send a user defined message to a user defined contact.

Hence, this invention enables a message to be automatically sent if certain user defined criteria defining a logical location are met. The usefulness of this is best illustrated in a scenario. The user can select a given logical location as the criteria much as one selects a ‘bookmark’ in a list of internet URLs. For this reason, we shall refer to this as selecting a ‘location bookmark’. Imagine now that Laura is on the train home from work. She has previously set a location bookmark on her wireless information device associated with the town of Colchester, which is on her way home. This can be done by her defining a logical location ‘Colchester’ with a particular geographic location (and predefined zone around that location) established using conventional location finding approaches—e.g. GPS or by manual user entry with WGS84 standard co-ordinates etc. She has also previously programmed her device so that when the device thinks it is in logical location ‘Colchester’ (using the conventional location finding approach(es)) it automatically sends a SMS text message to her husband Max saying “Passing through Colchester now”. Max then knows to set off to collect her from the next station.

Because the logical location Colchester is present in the list of possible criteria that can initiate a message to be sent, it is very easy for Laura to associate other actions with being in logical Colcehster, such as altering the device profile (e.g. ringing behaviour), automatically diverting all calls to voice mail, updating her Presence information to reflect the new status ‘coming home from work’ etc. This can be done through a simple series of linked menu lists—e.g. a first list which displays the primary criteria (such as a list of different logical locations—work, home; user—named places etc) and a linked list which shows a menu of possible actions to occur if the first criteria is met (e.g. send message to a user defined contact, forward calls to voice mail, update Presence in user defined manner, turn to silent mode etc.).

Location can typically be determined not only using a global or absolute reference frame location finding system such as GPS or time of arrival systems but also a local or relative reference frame location finding system, such as may be set up by short range RF transmitters (e.g. Bluetooth™ pods). Hence, a logical location ‘Home’ could be associated with a unique short range RF transmitter located at home. Then, for example, a school child could have a device that was set to send a SMS (“Home now”) to her working mother when the child arrives at logical location ‘Home’.

The criteria may also relate to an entity in a contacts application or list on the device. Hence, the device could be set to automatically send a SMS to a pre-defined contact if that contact's behaviour or Presence etc. met certain criteria: for example, consider the scenario in which Helen sets her device to send a SMS message to her husband Chris (e.g. “Please buy cinema tickets for tonight”) automatically if Chris changes his Presence setting from ‘Busy’.

This is also an example of the more general case of the criteria comprising a trigger event that must occur in order for the message to be sent.

The criteria may also comprise a validity time period during which the trigger event must occur in order for the message to be sent. For example, a SMS from Helen to Chris might only occur if he changes his Presence setting from Busy prior to 7 pm that day, since Helen knows that after that time it will be too late for Chris to buy the tickets anyway.

It is also possible to share and send criteria: the user defines the criteria by selecting an item from a list of possible items displayed on a first wireless information device that is different from the device whose behaviour is to be altered; that criteria is then sent to the device whose behaviour is to be altered, which then alters its behaviour when it satisfies the criteria received from the first device. It does so by automatically sending a user defined message to a user defined contact. For example, if a user loses his device, then he can define criteria that a device is to send its location to a device that the user can access and then disable itself; he then sends this instruction to his own, lost device, which promptly complies by sending its location back to the user and then disabling itself.

In a second aspect, there is a wireless information device capable of automatically altering its behaviour, the device being programmed to:
(a) enable a user to define one or more criteria defining a logical location by selecting an item from a list of possible logical locations displayed on the device; and
(b) alter its behaviour when the user defined criteria are satisfied by automatically sending a user defined message to a user defined contact.

In a third aspect, there is computer software which, when running on a wireless information device, enables the device to perform the method of the first aspect.

### BRIEF DESCRIPTION OF THE DRAWINGS

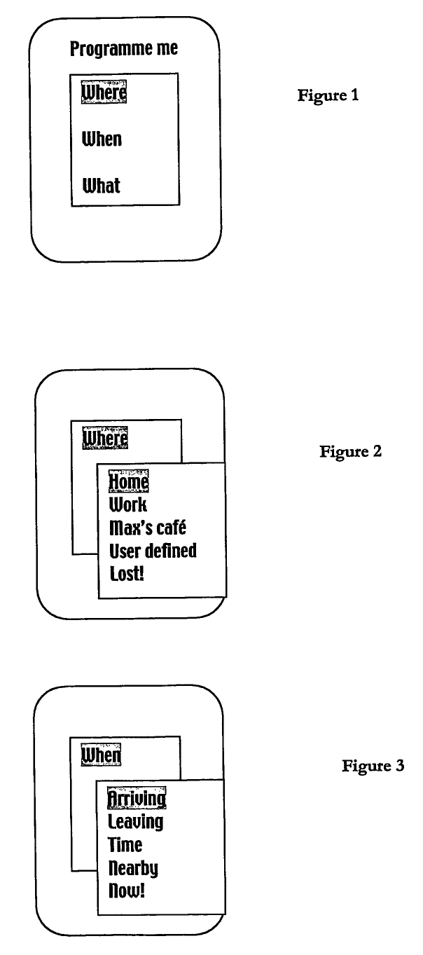

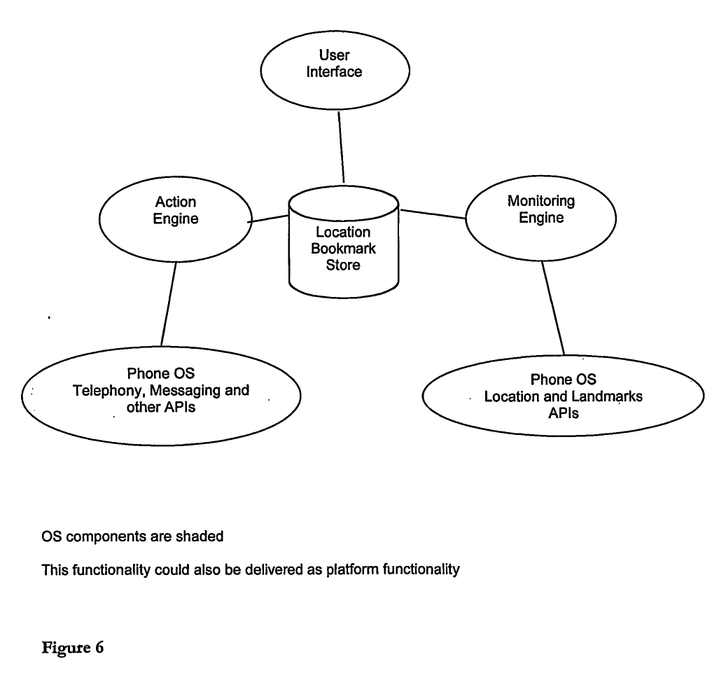

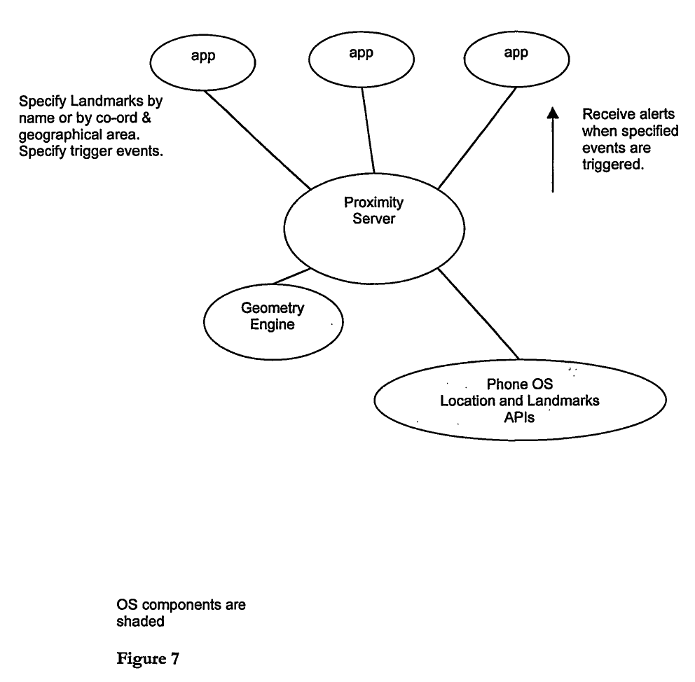

The present invention will be described with reference to the following drawings, in which FIG. 1-5 are representations of the user interaction when using the present invention and FIGS. 6 and 7 are schematics of an implementation.

### DETAILED DESCRIPTION

The present invention is implemented primarily as a system called ‘Location Bookmarks’. In this system, a known named location (e.g. a landmark) is associated by the wireless information device user with some trigger-event and some action. When the trigger-event occurs, the action is automatically carried out by the device. The action includes sending a message, but other kinds of actions are also possible.

Using the notation {Landmark, Trigger, Action}, examples might be:
{Office, Leave, SMS-Sally: “On way home”},
{Psychiatrist, Arrive, Reject-All-Location-Requests From Remote Users},
{Dry-Cleaners, Nearby, Display Reminder: “Pickup dry deaning”}

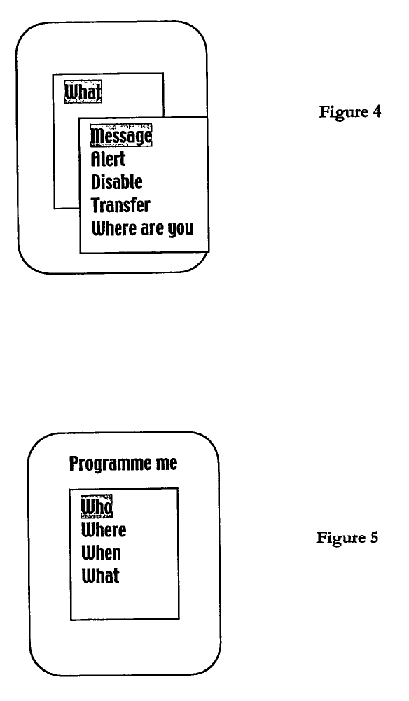

These associations are “location bookmarks”. They can be captured as selections from menu lists which define the criteria: Where, When and What, as shown in FIG. 1. If the user selects the ‘Where’ criteria, as shown in FIG. 1 with ‘Where’ highlighted, then the device displays the available ‘Where’ criteria, as depicted in FIG. 2. These include Home, Work, Max's café, User defined and Lost. If the user selects the logical Home item, the FIG. 3 screen is shown, giving the ‘When’ criteria; in this case: Arriving, Leaving, Time, Nearby and Now. The user selects the Arriving option and the device then proceeds to the ‘What’ criteria, as shown in FIG. 4. The user selects the ‘Message’ option, which causes the messaging application to open, allowing the user to draft and address a message, which will only be sent by the device automatically when the user is arriving at Home. This enables the scenario mentioned earlier, namely a school child with a device that sends a SMS (“Home now”) to her working mother when the child arrives at logical location ‘Home’.

If the user has lost his device, then he may, using another device equipped with the present functionality proceed through the above menus, selecting the sequence:
Lost! (this is in effect an empty or null field)
Now!
Where are you? (this prompts the user to give a phone number of the new device he is using).

When this is received by his lost device, it will automatically inform the user's new device (using the phone numbed of the new device supplied as described above) of its location and disable itself.

The Where/When/What structure allows a user to set up quite complex programmes on the device in a simple and intuitive manner.

This approach assumes that a landmark is a stored association between a user-friendly name and a geographical location or area. If an area, the area may be specified as either a 2D (horizontal plane) area or as a 3D (horizontal and vertical planes) area. Additionally, the area may be specified as either a rectangle (more generally a polygon) in each plane, or as a circle (more generally an ellipse) in each plane.

Location Bookmarks may be implemented as an application (hereafter “the app”) on top of a phone OS rather than as an integral OS-component. The location and landmarks APIs currently proposed for Symbian OS from Symbian Limited of London, United Kingdom, would permit the app to be built, whereby the app would enable users to associate landmarks from local and remote landmarks databases with trigger-events and actions. The app could use the location and landmarks APIs to monitor for trigger-events occurring, and could then use other OS APIs (e.g. messaging or telephony APIs) to carry out the user-specified actions.

A reference implementation of the app would require the following constituent parts:
a UI allowing the phone user to create, view, edit and delete location bookmarks by associating landmarks with trigger-events and actions,
a database (or simple data structure) maintaining the user-specified location bookmarks,
a monitoring engine that keeps track of the user's location and checks for the user-specified trigger-events
an action engine that interfaces to the phone OS to carry out the user-specified actions consequent on trigger-events.

This resulting architecture is shown in FIG. 6.

Additionally, a rules-engine could be implemented as part of the app to cater for more sophisticated relationships between landmarks and trigger-events.

The concept can be further extended to use more attributes for the location bookmarks. For example, a validity period:
{Office, Leave, Monday-Friday-1700-0800, SMS-Sally-“On Way Home”}
{KingsX, Arrive, Any-Saturday, SMS-Fred-“Let's party!”}

The concept can also be extended to treat location bookmarks as sharable entities in their own right. A user can send a location bookmark to another user (perhaps via SMS or some other delivery mechanism such as Bluetooth). The receiver can view and then either accept or reject the location bookmark. This would permit scenarios such as finding the location of a lost or stolen device (as described earlier). Another scenario is that Chris has heard that Sally may be coming to London at the weekend, and wants to be notified when she arrives so he can meet up with her. He constructs a location bookmark {Kings X, Arrive, Weekend, SMS-Chris-“Let's party!”}, and texts it to Sally. Sally receives the message, realises what it's for and accepts it When Sally's train arrives at Kings Cross on Saturday afternoon, her phone automatically texts Chris with the message “Let's party!”.

The app could be generalised to allow the user to create not only associations of the type
{landmark, trigger-event, action}
   but additionally of the type
{contact, trigger-event,action}.

Where contact may be one of:
a landmark (e.g. My Local Pub, the Texaco Filling Station), or
a person.

For instance
{Fred, Within-1 km-of, SMS-Fred-“Shall we meet up?”}.

The Where/When/What structure could then be extended to a Who/Where/When/What structure, as shown in FIG. 5. The crucial factor here is that whereas landmarks are essentially static entities (e.g. office, home, Eiffel Tower), a person is by definition mobile—i.e. his location or associated “area” will change.

It is worth noting that landmarks, although inherently static, are just user-defined data, and so might be subject to change by the user (e.g. change of name, change of co-ords, change of area). Due to the dynamic nature of a person's location, the monitoring engine shown in FIG. 6 will need to be extended (or replaced) by a more sophisticated engine that tracks not only the phone user's location, but also that of the contacts he/she has set-up associations for. This in turn assumes an ability to query location of individuals over the network.

One important feature of the concept is the monitoring engine that monitors the location of the user and of other contacts specified in associations, and checks for the user-specified trigger-events. This feature could usefully be split out into an OS platform feature, hereafter referred to as a “proximity server”, shown in FIG. 7.

A proximity server makes use of whatever location technologies and quality criteria are available on the phone, providing an additional layer of encapsulation from the OS location APIs. The proximity server has sophisticated 2D and 3D geometry calculation engines that carry out and optimise the calculations necessary for checking for trigger-events. The proximity server provides an API for apps to register their trigger events in terms of named landmarks or as geometrical areas, and receive notifications in return when the trigger event is detected.

1. A method of automatically altering the behaviour of a wireless information device, comprising the steps of:
(a) enabling a user to define criteria by selecting an item from a list of possible logical locations displayed on the device;
(b) altering the behaviour of the device when that device satisfies the user defined logical location criteria by causing the device to automatically send a user defined message to a user defined contact.

2. The method of claim 1 wherein the logical location is selected from a displayed menu list comprising one or more of the following logical locations:
work; home; user-named places; lost.

3. The method of claim 2 comprising the further step of enabling a user to define further criteria defining a trigger event that must occur in order for the message to be sent.

4. The method of claim 3 wherein the trigger event is defined by being selected from a displayed menu list comprising one or more of the following trigger events:
arriving; leaving; time; nearby; now.

5. The method of claim 3 comprising the further step of enabling a user to define additional ways in which the behaviour of the device is altered.

6. The method of claim 5 in which the additional ways are selected from a displayed menu list comprising one or more of the following:
forward calls to voice mail; update Presence in user defined manner; turn to silent mode or otherwise alter profile.

7. The method of claim 1 wherein the device is capable of determining its location using one or more of:
(a) a global or absolute reference frame location finding system;
(b) a local or relative reference frame location finding system.

8. The method of claim 4 wherein the criteria comprises a validity time period during which the trigger event must occur in order for the message to be sent.

9. The method of claim 1 in which the user defines the criteria by selecting an item from a list of possible items displayed on a first wireless information device that is different from the device whose behaviour is to be altered; and that criteria is sent to the device whose behaviour is to be altered which then alters its behaviour when it satisfies the criteria received from the first device by automatically sending a user defined message to a user defined contact.

10. The method of claim 1 in which the criteria enable a lost or stolen device to automatically send a message with that device's location to a user defined device.

11. A wireless information device capable of automatically altering its behaviour, the device being programmed to:
(a) enable a user to define criteria by selecting an item from a list of possible logical locations displayed on the device; and
(b) alter its behaviour when the user defined logical location criteria are satisfied by automatically sending a user defined message to a user defined contact.

12. The device of claim 11 wherein the logical location is selected from a displayed menu list comprising one or more of the following logical locations:
work; home; user-named places; lost.

13. The device of claim 12 operable to enable a user to define criteria defining a trigger event that must occur in order for the message to be sent.

14. The device of claim 13 wherein the trigger event is defined by being selected from a displayed menu list comprising one or more of the following trigger events:
arriving; leaving; time; nearby; now.

15. The device of claim 13 operable to enable a user to define additional ways in which the behaviour of the device is altered.

16. The device of claim 15 in which the additional ways are selected from a displayed menu list comprising one or more of the following:
forward calls to voice mail; update Presence in user defined manner; turn to silent mode or otherwise alter profile.

17. The device of claim 11 capable of determining its location using one or more of:
(a) a global or absolute reference frame location finding system;
(b) a local or relative reference frame location finding system.

18. The device of claim 14 wherein the criteria comprises a validity time period during which the trigger event must occur in order for the message to be sent.

19. The device of claim 11 in which the user defines the criteria by selecting an item from a list of possible items displayed on a different wireless information device and that criteria is sent to the device which then alters its behaviour when it satisfies the criteria received from the different device by causing the device to automatically send a user defined message to a user defined contact.

20. The device of claim 11 for which the criteria enable it, when lost or stolen, to automatically send a message with its location to a user defined device.

21. Computer software which, when running on a wireless information device, enables the device to perform the method of claim 1.
